(19) United States
(12) Patent Application Publication
(10) Pub. No.: US 2024/0297893 A1
(43) Pub. Date: Sep. 5, 2024

(54) DYNAMIC QUARANTINING OF CONTAINERS

(71) Applicant: INTERNATIONAL BUSINESS MACHINES CORPORATION, ARMONK, NY (US)

(72) Inventors: Md Salman Ahmed, Danbury, CT (US); Michael Vu Le, Danbury, CT (US); Hani Talal Jamjoom, Cos Cob, CT (US)

(21) Appl. No.: 18/178,508

(22) Filed: Mar. 5, 2023

(51) Int. Cl. H04L 9/40; G06F 9/48

(52) U.S. Cl. CPC H04L 63/1433; G06F 9/4881; H04L 63/1416

(57) ABSTRACT

Described are techniques for dynamic quarantining of containers. The techniques include a system including a plurality of computing nodes configured to implement a plurality of queued containers. The system further includes a container scheduler comprising at least one plugin, where the at least one plugin is configured to cause the container scheduler to perform a method including assigning cybersecurity risk scores to the plurality of queued containers. The method further includes assigning cybersecurity risk tolerances to the plurality of computing nodes. The method further includes scheduling the plurality of queued containers to the plurality of computing nodes based on compatible combinations of the cybersecurity risk scores and the cybersecurity risk tolerances.

### BACKGROUND

The present disclosure relates to cybersecurity of containers, and, more specifically, to a dynamic quarantining mechanism for containers implemented in a cloud environment.

Containers are isolated runtime environments that can implement containerized applications. Containers can encapsulate an application with its dependencies (e.g., system libraries, binaries, configuration files, etc.). In contrast to virtual machines (VMs), containers do not include an operating system (OS). Instead, containers share an OS with a host system implementing the container. As a result, containers are portable (e.g., write once, run anywhere), lightweight (e.g., no OS), and scalable.

### SUMMARY

Aspects of the present disclosure are directed toward a system including a plurality of computing nodes configured to implement a plurality of queued containers. The system further includes a container scheduler comprising at least one plugin, where the at least one plugin is configured to cause the container scheduler to perform a method including assigning cybersecurity risk scores to the plurality of queued containers. The method further includes assigning cybersecurity risk tolerances to the plurality of computing nodes. The method further includes scheduling the plurality of queued containers to the plurality of computing nodes based on compatible combinations of the cybersecurity risk scores and the cybersecurity risk tolerances.

Additional aspects of the present disclosure are directed toward a computer-implemented method including installing one or more plugins to a container scheduler configured to bind containers to nodes in a production environment. The method further includes executing the one or more plugins to assign cybersecurity risk scores to queued containers, assign cybersecurity risk tolerances to the nodes in the production environment, and schedule the queued containers to the nodes based on compatible combinations of the cybersecurity risk scores and the cybersecurity risk tolerances.

Additional aspects of the present disclosure are directed to systems and computer program products configured to perform the method described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example computational environment implementing a scheduler at a first time, in accordance with some embodiments of the present disclosure.

FIG. 2 illustrates a block diagram of an example computational environment implementing a scheduler at a second time, in accordance with some embodiments of the present disclosure.

FIG. 3 illustrates a flowchart of an example method for dynamically quarantining queued containers, in accordance with some embodiments of the present disclosure.

FIG. 4 illustrates a flowchart of an example method for dynamically quarantining running containers, in accordance with some embodiments of the present disclosure.

FIG. 5 illustrates a flowchart of an example method for dynamically quarantining containers using plugins, in accordance with some embodiments of the present disclosure.

FIG. 6 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward cybersecurity of containers, and, more specifically, to a dynamic quarantining mechanism for containers implemented in a cloud environment. While not limited to such applications, embodiments of the present disclosure may be better understood in light of the aforementioned context.

Containers can be exposed to cybersecurity vulnerabilities through, for example, certain system calls, certain library usages, and/or certain cybersecurity policy violations. A compromised container can cause vulnerabilities and/or performance degradation in other containers running on the same node as the vulnerable container. As a result, in a cloud environment with containers exposed to known cybersecurity vulnerabilities intermingled with tens, hundreds, or thousands of other containers, malicious activities against the vulnerable containers can cause widespread performance degradation and/or container compromise amongst the other containers across numerous nodes.

Traditional strategies for managing container vulnerabilities require manual intervention. That is, manually identifying vulnerable containers and manually scheduling vulnerable containers to a designated node. However, manual intervention is impractical at scale. Furthermore, manual intervention is susceptible to user error.

Aspects of the present disclosure are directed to automatically quarantining high-risk containers (e.g., containers with cybersecurity vulnerabilities) into one or more high-risk nodes. In this way, aspects of the present disclosure can isolate high-risk containers from benign containers in a production environment. By isolating high-risk containers from benign containers, aspects of the present disclosure can limit the spread of damage from malicious activity against the high-risk containers.

Additional aspects of the present disclosure are directed to generating a risk score for each container and assigning a risk tolerance to each node. Advantageously, using risk scores and risk tolerances enables aspects of the present disclosure to quarantine highest-risk containers (e.g., highest risk scores) on a highest-risk node (e.g., highest risk tolerance), relatively less risky containers (e.g., relatively lower risk scores) on a relatively less risky node (e.g., relatively lower risk tolerance), and so on. This granularity can result in higher overall security and lower overall risk in a production environment deploying tens, hundreds, or thousands of containers with varying levels of cybersecurity vulnerabilities.

Additional aspects of the present disclosure are directed to automatically scheduling, descheduling, and/or migrating running containers in a production environment. Additionally, if a node becomes available at runtime (e.g., all the containers in that node finish their execution), aspects of the present disclosure can replace the node's risk tolerance with a null risk tolerance, indicating the node is available. Advantageously, the methods used to schedule, deschedule, and/or migrate running containers in a production environment enable aspects of the present disclosure to dynamically quarantine high-risk containers, even when those high-risk containers are already scheduled in an intermingled fashion with the benign containers in the production environment.

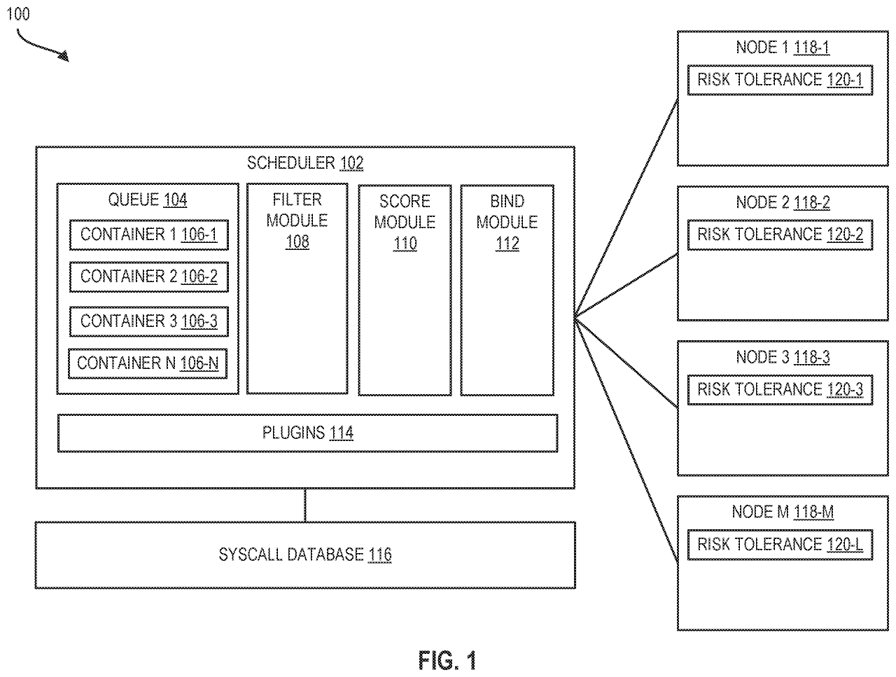

Referring now to the figures, FIG. 1 illustrates a block diagram of an example computational environment 100 implementing a scheduler 102 at a first time, in accordance with some embodiments of the present disclosure. The scheduler 102 is configured to select a node from nodes 118 for a container from containers 106 and assign the container to the selected node. Containers 106 can include container 1 106-1, container 2 106-2, container 3 106-3, and container N 106-N (where N can be any positive integer representing any number of containers). Likewise, nodes 118 can include node 1 118-1, node 2 118-2, node 3 118-3, and node M 118-M (where M can be any positive integer representing any number of nodes).

The scheduler 102 can be any container scheduler, now known or later developed. In some embodiments, the scheduler 102 is a KUBERNETES® scheduler. The scheduler 102 includes a queue 104 storing containers 106, a filter module 108 for identifying nodes 118 capable of running respective containers 106 and filtering out other nodes 118 that are incapable of running respective containers 106 (e.g., due to resource constraints, anti-affinity relationships, etc.), and a score module 110 for translating the workload characteristics into metrics to enable effective assignment of containers 106 to nodes 118 through raking of candidate nodes for a container. Scheduler 102 further includes a bind module 112 for assigning respective containers 106 to respective nodes 118 based on scores from the score module 110.

Scheduler 102 further includes one or more plugins 114. Plugins 114 can refer to auxiliary functionality provided to the scheduler 102 for automated dynamic quarantining of containers in a cloud environment. More specifically, the plugins 114 can enable the filter module 108 to detect security vulnerabilities and compute risk scores for each container from the containers 106. For example, the plugins 114 can access a syscall database 116 storing known system call vulnerabilities (or other vulnerabilities) and compare system call information in respective containers to the syscall database 116.

Furthermore, the plugins 114 can cause the filter module 108 to generate risk scores (not shown) for the containers. The risk scores can be based on, but not limited to, containers 106 with access to code having known security vulnerabilities, containers 106 with access to software that is flagged by Cloud Service Providers (CSPs) or by a security policy, containers 106 that are flagged by an Intrusion Detection System (IDS), the Common Vulnerabilities and Exposures (CVE) dataset and the Common Vulnerability Scoring System (CVSS), and/or other factors.

Furthermore, the plugins 114 can be configured to associate a risk tolerance 120 (e.g., risk tolerance 120-1, risk tolerance 120-2, risk tolerance 120-3, and risk tolerance 120-L, where L can be any positive integer representing any number of risk tolerances) for each node 118. Risk tolerances 120 can be ranges of risk scores. In some embodiments, risk tolerances 120 can be binary (e.g., a quarantined, high-risk risk tolerance and a non-quarantined, benign risk tolerance). In other embodiments, risk tolerances 120 can be scaled in predetermined intervals of risk scores. In yet other embodiments, risk tolerances 120 can be determined based on the risk scores of the containers 106, thereby enabling the risk tolerances 120 of each node 118 to be tailored to allow for load-balancing of the containers 106 amongst the nodes 118 in a risk-aware manner.

Referring back to the scheduler 102, when the scheduler 102 is a KUBERNETES® scheduler, aspects of the present disclosure can utilize the taint and toleration features of KUBERNETES® to implement aspects of the present disclosure. For example, the risk tolerances 120 can take the form of respective taints applied to respective nodes 118, and the risk scores of the containers 106 can take the form of respective tolerations applied to respective containers 106, where the tolerations enable a corresponding container 106 to tolerate (e.g., be runnable upon) a node 118 with a given taint.

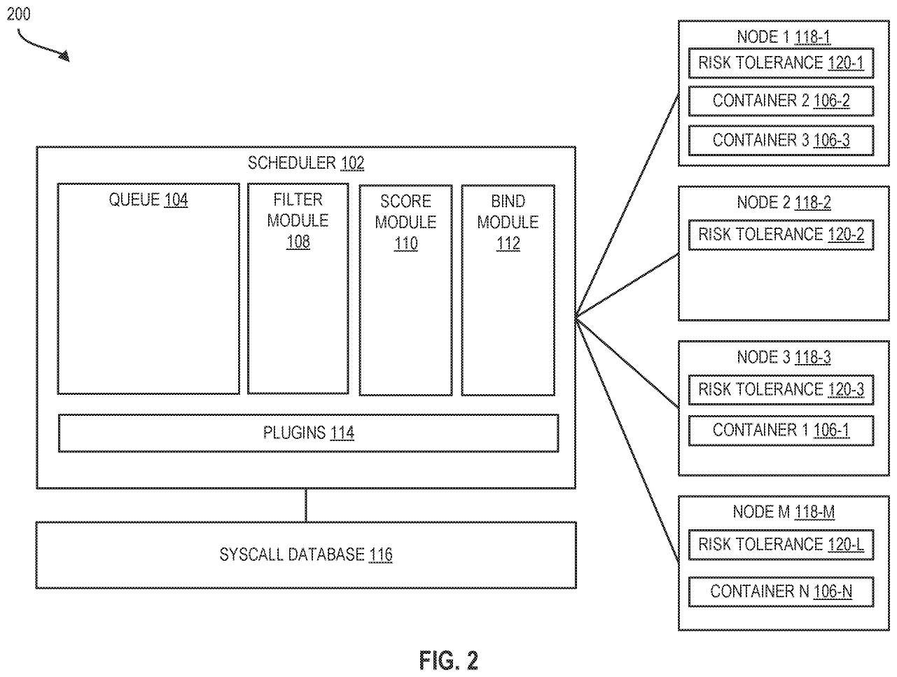

FIG. 2 illustrates a block diagram of an example computational environment 200 implementing the scheduler 102 at a second time after the first time as shown in FIG. 1, in accordance with some embodiments of the present disclosure. As shown in FIG. 2, the containers 106 are assigned to one of the plurality of nodes 118 based on compatible combinations of the risk scores of the containers 106 and the risk tolerances 120 of the nodes 118. In some embodiments, each container 106 can have a risk score falling within a range defined by the risk tolerance 120 of the node 118 implementing the container 106. In other embodiments, each container 106 implemented on a node 118 can have a risk score that is relatively closer to the risk tolerance 120 of the node 118 than other risk tolerances 120 of other nodes 118.

As shown in FIG. 2, node 1 118-1 can have container 2 106-2 and container 3 106-3 implemented thereon. Node 2 118-2 can have no containers 106 implemented thereon. Node 3 118-3 can have container 1 106-1 implemented thereon. Finally, node M 118-M can have container N 106-N implemented thereon. As described above and shown in FIG. 2, some nodes 118 can host multiple containers 106, some nodes 118 can host a single container 106, and some nodes 118 can host no containers 106 depending on the risk scores of the containers 106 and the risk tolerances 120 of the nodes 118.

As an example of binary risk tolerances 120, node 3 118-3 can be designated as a single high-risk node, and the remaining nodes 118 can be designated as benign (e.g., non-high-risk) nodes 118. In such an example, container 1 106-1 can be determined to have cybersecurity vulnerabilities and be assigned to the high-risk node (e.g., node 3 118-3) while the remaining containers 106 (that are benign) can be assigned to other nodes 118.

As an example of ranged risk tolerances 120, node 1 118-1 can have a relatively lowest risk tolerance 120-1, node M 118-M can have a relatively highest risk tolerance 120-L, and node 2 118-2 and node 3 118-3 can have a risk tolerance 120-2 and risk tolerance 120-3, respectively, ranging between risk tolerance 120-1 and risk tolerance 120-L. In this example, container 2 106-2 and container 3 106-3 can have relatively lowest risk scores and be considered benign containers. As a result, container 2 106-2 and container 3 106-3 are implemented on node 1 118-1 with the relatively lowest risk tolerance 120-1. In case of multiple nodes with same risk tolerance (e.g., risk tolerance 120-1) available for a container, the traditional scoring metrics are used to rank the nodes to select the best candidate for the container using the score module 110. Meanwhile, container N 106-N can have a highest risk score and therefore be implemented on node M 118-M with the relatively highest risk tolerance 120-L. Finally, container 1 106-1 implemented on node 3 118-3 can have a risk score relatively higher than container 2 106-2 and container 3 106-3 while being relatively lower than container N 106-N. More specifically, the risk score of container 1 106-1 can be within (or nearest) the risk tolerance 120-3 of node 3 118-3.

Although node 2 118-2 is shown as having risk tolerance 120-2, in some embodiments, empty nodes 118 (e.g., node 2 118-2) can have a null risk tolerance 120 until the scheduler 102 is prepared to schedule additional containers 106. At that time, the null risk tolerance 120 of an empty node can be updated to meet the needs of the to-be-scheduled containers 106.

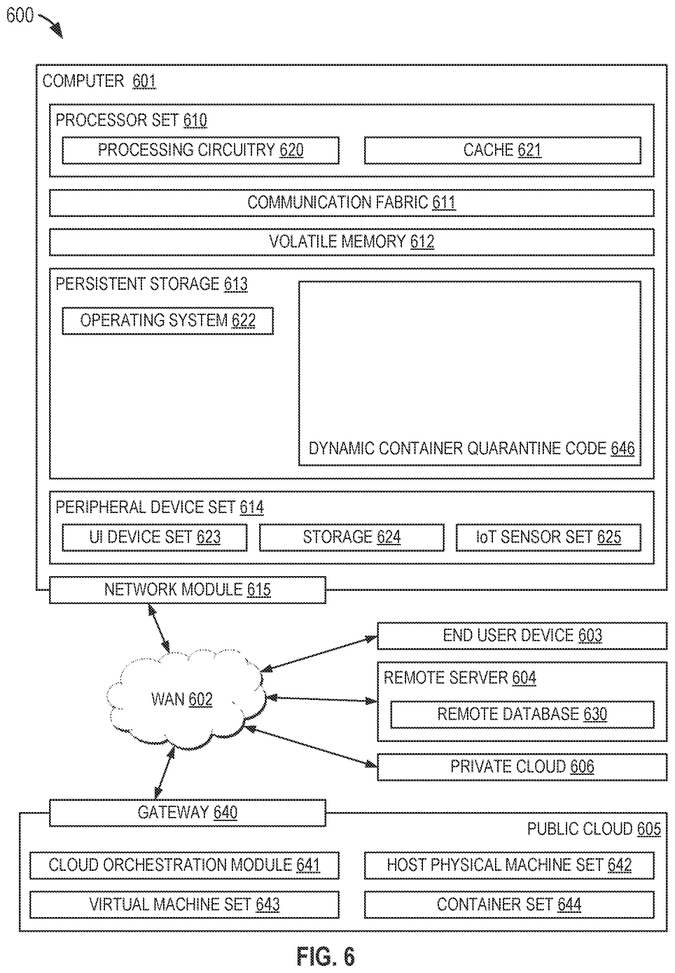

FIGS. 1 and 2 are for illustrative purposes and should not be construed as limiting. More, fewer, and/or different components than the components illustrated in FIGS. 1 and 2 can be present while remaining within the spirit and scope of the present disclosure. Further, illustrated components can be separated into multiple, discrete components, and/or multiple discrete components can be combined together into a single component, while remaining within the spirit and scope of the present disclosure. Additionally, although aspects of the present disclosure are shown as implemented by plugins 114 together with scheduler 102, in other embodiments, aspects of the present disclosure can be incorporated directly into scheduler 102 without the need for plugins 114. Further, the functionality provided by plugins 114 can be provided by dynamic container quarantine code 646 as discussed hereinafter with respect to FIG. 6. Finally, although not explicitly shown in FIGS. 1 and 2, in some embodiments, a container descheduler additionally performs some aspects of the present disclosure and the container scheduler performs other aspects of the present disclosure. In such embodiments, the container descheduler can be referred to as a deployment controller that sits parallelly with the scheduler in the KUBERNETES® control plane and monitors and manages the system state.

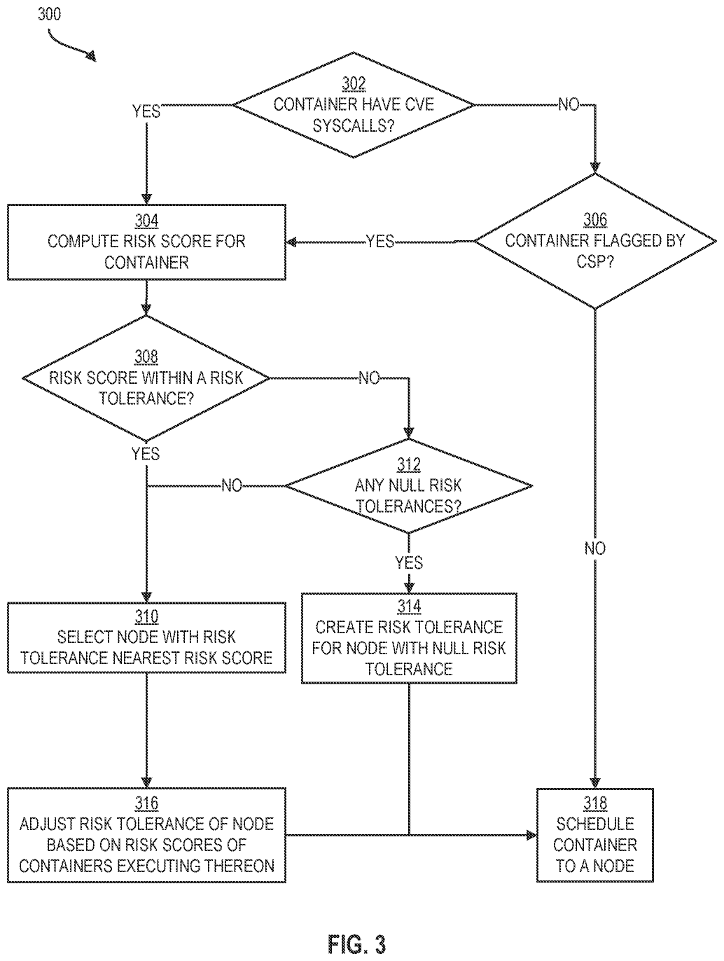

FIG. 3 illustrates a flowchart of an example method 300 for dynamically quarantining queued containers, in accordance with some embodiments of the present disclosure. The method 300 can be implemented by one or more components of FIGS. 1, 2, and/or 6. In some embodiments, the method 300 is implemented by one or more plugins 114 together with a scheduler 102 (as in FIG. 1). In some embodiments, the method 300 is implemented by dynamic container quarantine code 646 implemented on a computer 601 (as in FIG. 6).

Operation 302 determines whether a given container has a Common Vulnerabilities and Exposures (CVE) syscall. In some embodiments, operation 302 can compare container code to a CVE syscall database (e.g., syscall database 116 of FIG. 1) to identify whether or not the given container has a CVE syscall. If so (302: YES), the method 300 proceeds to operation 304 and computes a risk score associated with the given container. If not (302: NO), the method 300 proceeds to operation 306 and determines if the given container is flagged by a Cloud Service Provider (CSP). If so (306: YES), the method 300 proceeds to operation 304 and computes a risk score for the given container. If not (306: NO), the method 300 proceeds to operation 318 and schedules the given container to a node using traditional factors, metrics, and/or techniques. Operation 318 can schedule the given container to the node as a benign container insofar as the given container has no CVE syscalls and is not flagged by a CSP.

Referring back to operation 304, after computing the risk score for the container, the method 300 proceeds to operation 308. Operation 308 determines whether the risk score of the container is within any risk tolerance of any node. If so (308: YES), then the method 300 proceeds to operation 310 and selects the node with the risk tolerance that is nearest the risk score of the container. If not (308: NO), then the method 300 proceeds to operation 312.

Operation 312 determines whether there are any null risk tolerances associated with any nodes in the production environment. A null risk tolerance can indicate an available (e.g., empty) node. For example, if a node becomes available at runtime (e.g., all the containers in that node finish their execution) aspects of the present disclosure can replace the node's risk tolerance with the null risk tolerance, indicating the node is available. If not (312: NO), then the method. 300 proceeds to operation 310 and assigns the container to the node with the risk tolerance nearest the risk score. If so (312: YES), then the method 300 proceeds to operation 314 and creates a risk tolerance to replace the null risk tolerance in the empty node. The created risk tolerance can be based on the risk score of the given container in order to ensure that the given container can be assigned to the node with the newly created risk tolerance. The method 300 then proceeds to operation 318.

Referring back to operation 310, after completing operation 310, the method 300 proceeds to operation 316. Operation 316 can adjust the risk tolerance of the node based on the risk scores of the containers executing thereon (including the newly assigned container). For example, the risk tolerance can be adjusted based on an average of the risk scores of the containers executing on the node. As another example, the risk tolerance can be adjusted to capture each risk score of the containers executing on the node. In this way, risk tolerances of respective nodes can dynamically change over time based on the containers implemented on those nodes.

After either operation 316 or 314, the method 300 proceeds to operation 318 and schedules the container to the node. As previously discussed, in KUBERNETES® implementations, additional operations (not shown) can be performed that apply taints to nodes (representing risk tolerances) and tolerations to containers (representing risk scores) in order to manage which containers can be scheduled to which nodes. The method 300 can be repeated until all containers are assigned to a node from a queue of a scheduler.

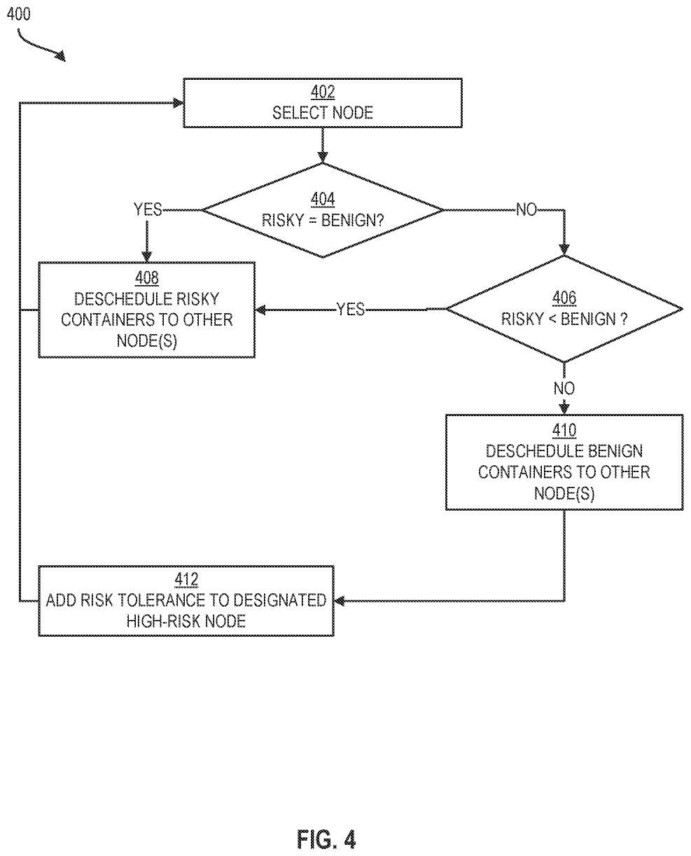

FIG. 4 illustrates a flowchart of an example method 400 for dynamically quarantining running containers, in accordance with some embodiments of the present disclosure. The method 400 can be implemented by one or more components of FIGS. 1, 2, and/or 6. In some embodiments, the method 400 is implemented by one or more plugins in a deployment controller. With respect to the KUBERNETES® implementations, the deployment controller is a descheduler that sits parallelly with the scheduler in the KUBERNETES® control plane and monitors and manages the system state. In some embodiments, the method 400 is implemented by dynamic container quarantine code 646 implemented on a computer 601 (as in FIG. 6). In some embodiments, the method 400 occurs prior to the method 300 of FIG. 3 insofar as the method 400 can dynamically quarantine already running high-risk containers from already running benign containers in a production environment.

Operation 402 selects a node of the production environment for evaluation. Operation 404 determines if the number of benign containers running on the node is equal to the number of high-risk containers running on the node. If so (404: YES), the method 400 proceeds to operation 408 and deschedules the high-risk containers to one or more other nodes (thereby causing the node to become a benign, non-quarantined node). The method 400 then returns to operation 402 and selects a new node.

Referring back to operation 404, if the number of benign contains is not equal to the number of high-risk containers (404: NO), then the method 400 proceeds to operation 406 and determines if there are fewer high-risk containers than benign containers running on the node. If there are fewer high-risk containers than benign containers running on the node (406: YES), then the method proceeds to operation 408 and deschedules the high-risk containers to other nodes (thereby causing the node to become a benign, non-quarantined node) and returns again to operation 402 and selects a new node for evaluation. If there are more high-risk containers than benign containers running on the node (406: NO), then the method 400 proceeds to operation 410 and deschedules the benign containers to one or more other nodes (thereby making the selected node a quarantined high-risk node). The method 400 then proceeds to operation 412 and adds a risk tolerance to the designated node consistent with the remaining, high-risk containers running thereon. In a KUBERNETES® implementation, operation 412 applies a taint to the designated node and a toleration that is compatible with the taint to the high-risk containers running thereon. After operation 412, the method 400 returns again to operation 402 and selects a new node for evaluation.

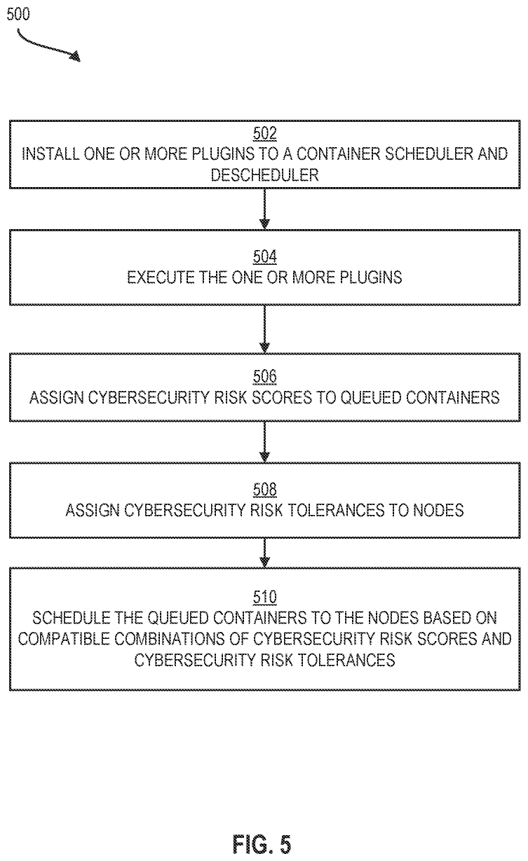

FIG. 5 illustrates a flowchart of an example method 500 for dynamically quarantining containers using plugins, in accordance with some embodiments of the present disclosure. The method 500 can be implemented by one or more components of FIGS. 1, 2, and/or 6. In some embodiments, the method 500 is implemented by one or more plugins 114 together with a scheduler 102 (as in FIG. 1). In some embodiments, the method 500 is implemented by dynamic container quarantine code 646 implemented on a computer 601 (as in FIG. 6).

Operation 502 includes installing one or more plugins (e.g., plugins 114 of FIG. 1) to a container scheduler (e.g., scheduler 102 of FIG. 1) and descheduler. The installed plugins can include executable program code (e.g., dynamic container quarantine code 646 of FIG. 6) configured to cause the scheduler to assign containers to nodes based, at least in part, on compatible combinations of risk scores for the containers and risk tolerances for the nodes.

Operation 504 includes executing the one or more plugins to implement the functionality of the plugins. Operation 504 can include, for example, operations 506, 508, and 510.

Operation 506 includes assigning cybersecurity risk scores to queued containers in the scheduler. The cybersecurity risk scores can be binary scores (e.g., benign or high-risk), continuous value scores, or a set of more than two classifications based on predefined thresholds applied to continuous value scores. Operation 508 includes assigning cybersecurity risk tolerances to nodes configured to run the queued containers. Operation 510 includes scheduling the queued containers to the nodes based on compatible combinations of the cybersecurity risk scores and the cybersecurity risk tolerances. Compatible combinations of cybersecurity risk scores and cybersecurity risk tolerances can be, for example, (i) a cybersecurity risk score that falls within a range defined by a cybersecurity risk tolerance, or (ii) a cybersecurity risk score that is relatively closer to a given cybersecurity risk tolerance than other cybersecurity risk tolerances.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 6 illustrates a block diagram of an example computing environment, in accordance with some embodiments of the present disclosure. Computing environment 600 contains an example of an environment for the execution of at least some of the computer code involved in performing the inventive methods, such as dynamic container quarantine code 646. In addition to dynamic container quarantine code 646, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and dynamic container quarantine code 646, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in dynamic container quarantine code 646 in persistent storage 613.

Communication fabric 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in dynamic container quarantine code 646 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,”“an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding of the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is a system. The system includes a plurality of computing nodes configured to implement a plurality of queued containers; a container scheduler comprising at least one plugin, wherein the at least one plugin is configured to cause the container scheduler to perform a method comprising: assigning cybersecurity risk scores to the plurality of queued containers; assigning cybersecurity risk tolerances to the plurality of computing nodes; and scheduling the plurality of queued containers to the plurality of computing nodes based on compatible combinations of the cybersecurity risk scores and the cybersecurity risk tolerances.

Example 2 includes the features of Example 1. In this example, the cybersecurity risk scores are based on one or more selected from a group consisting of: queued containers with access to code having known security vulnerabilities, queued containers with access to software that is flagged by a CSP or by a security policy, queued containers that are flagged by an Intrusion Detection System (IDS), and a Common Vulnerabilities and Exposures (CVE) dataset and a Common Vulnerability Scoring System (CVSS).

Example 3 includes the features of any one of Examples 1 to 2. In this example, assigning the cybersecurity risk scores to the plurality of queued containers further comprises assigning additional cybersecurity risk scores to running containers. Optionally, the at least one plugin is further configured to cause the container scheduler to perform the method further comprising (i) migrating benign running containers from a first node to a benign node in response to the first node having more high-risk running containers than benign running containers, (ii) migrating high-risk running containers from a second node to a high-risk node in response to the second node having more benign running containers than high-risk running containers, and/or (iii) migrating high-risk running containers from a third node to a high-risk node in response to the third node having an equal number of benign running containers and high-risk running containers.

Example 4 is a computer-implemented method. The computer-implemented method comprising installing one or more plugins to a container scheduler configured to bind containers to nodes in a production environment; and executing the one or more plugins to: assign cybersecurity risk scores to queued containers; assign cybersecurity risk tolerances to the nodes in the production environment; and schedule the queued containers to the nodes based on compatible combinations of the cybersecurity risk scores and the cybersecurity risk tolerances.

Example 5 includes the features of Example 4. In this example, the cybersecurity risk scores are based on one or more selected from a group consisting of: queued containers with access to code having known security vulnerabilities, queued containers with access to software that is flagged by a CSP or by a security policy, queued containers that are flagged by an Intrusion Detection System (IDS), and a Common Vulnerabilities and Exposures (CVE) dataset and a Common Vulnerability Scoring System (CVSS).

Example 6 includes the features of any one of Examples 4 to 5. In this example, assigning the cybersecurity risk scores to the queued containers further comprises assigning additional cybersecurity risk scores to running containers, and wherein executing the one or more plugins further comprises: (i) migrating benign running containers from a first node to a benign node in response to the first node having more high-risk running containers than benign running containers, (ii) migrating high-risk running containers from a second node to a high-risk node in response to the second node having more benign running containers than high-risk running containers, and/or (iii) migrating high-risk running containers from a third node to a high-risk node in response to the third node having an equal number of benign running containers and high-risk running containers.

Example 7 includes the features of any one of examples 4 to 6. In this example, the cybersecurity risk tolerances are adjusted based on the cybersecurity risk scores to load-balance the queued containers on the nodes.

Example 8 includes the features of any one of Examples 4 to 7. In this example, the container scheduler is a Kubernetes container scheduler, wherein the cybersecurity risk scores are converted to respective tolerations for the containers, and wherein the cybersecurity risk tolerances are converted to respective taints for the nodes.

Example 9 is a system. The system includes one or more computer readable storage media storing program instructions; and one or more processors which, in response to executing the program instructions, are configured to perform a method according to any one of Examples 4 to 8, including or excluding optional features.

Example 10 is a computer program product. The computer program product includes one or more computer readable storage media, and program instructions collectively stored on the one or more computer readable storage media, the program instructions comprising instructions configured to cause one or more processors to perform a method according to any one of Examples 4 to 8, including or excluding optional features.

What is claimed is:

1. A system comprising:
a plurality of computing nodes configured to implement a plurality of queued containers;
a container scheduler comprising at least one plugin, wherein the at least one plugin is configured to cause the container scheduler to perform a method comprising:
assigning cybersecurity risk scores to the plurality of queued containers;
assigning cybersecurity risk tolerances to the plurality of computing nodes; and
scheduling the plurality of queued containers to the plurality of computing nodes based on compatible combinations of the cybersecurity risk scores and the cybersecurity risk tolerances.

2. The system of claim 1, wherein the cybersecurity risk scores are based on containers with access to code having known security vulnerabilities.

3. The system of claim 1, wherein the cybersecurity risk scores are based on containers with access to software that is flagged by a Cloud Service Provider (CSP) or by a security policy.

4. The system of claim 1, wherein the cybersecurity risk scores are based on containers that are flagged by an Intrusion Detection System (IDS).

5. The system of claim 1, wherein the cybersecurity risk scores are based on a Common Vulnerabilities and Exposures (CVE) dataset and a Common Vulnerability Scoring System (CVSS).

6. The system of claim 1, wherein assigning the cybersecurity risk scores to the plurality of queued containers further comprises assigning additional cybersecurity risk scores to running containers, and wherein the at least one plugin is further configured with a controller entity to cause the container scheduler to perform the method further comprising:
migrating benign running containers from a first node to a benign node in response to the first node having more high-risk running containers than the benign running containers.

7. The system of claim 1, wherein assigning the cybersecurity risk scores to the plurality of queued containers further comprises assigning additional cybersecurity risk scores to running containers, and wherein the at least one plugin is further configured with a controller entity to cause the container scheduler to perform the method further comprising:
migrating high-risk running containers from a second node to a high-risk node in response to the second node having more benign running containers than the high-risk running containers.

8. The system of claim 1, wherein assigning the cybersecurity risk scores to the plurality of queued containers further comprises assigning additional cybersecurity risk scores to running containers, and wherein the at least one plugin is further configured with a controller entity to cause the container scheduler to perform the method further comprising:
migrating high-risk running containers from a third node to a high-risk node in response to the third node having an equal number of benign running containers and the high-risk running containers.

9. A computer-implemented method comprising:
installing one or more plugins to a container scheduler configured to bind containers to nodes in a production environment; and
executing the one or more plugins to:
assign cybersecurity risk scores to queued containers;
assign cybersecurity risk tolerances to the nodes in the production environment; and
schedule the queued containers to the nodes based on compatible combinations of the cybersecurity risk scores and the cybersecurity risk tolerances.

10. The method of claim 9, wherein the cybersecurity risk scores are based on containers with access to code having known security vulnerabilities.

11. The method of claim 9, wherein the cybersecurity risk scores are based on containers with access to software that is flagged by a Cloud Service Provider (CSP) or by a security policy.

12. The method of claim 9, wherein the cybersecurity risk scores are based on containers that are flagged by an Intrusion Detection System (IDS).

13. The method of claim 9, wherein the cybersecurity risk scores are based on a Common Vulnerabilities and Exposures (CVE) dataset and a Common Vulnerability Scoring System (CVSS).

14. The method of claim 9, wherein assigning the cybersecurity risk scores to the queued containers further comprises assigning additional cybersecurity risk scores to running containers, and wherein executing the one or more plugins configured with a controller entity further comprises:
migrating benign running containers from a first node to a benign node in response to the first node having more high-risk running containers than the benign running containers.

15. The method of claim 9, wherein assigning the cybersecurity risk scores to the queued containers further comprises assigning additional cybersecurity risk scores to running containers, and wherein executing the one or more plugins configured with a controller entity further comprises:
migrating high-risk running containers from a second node to a high-risk node in response to the second node having more benign running containers than the high-risk running containers.

16. The method of claim 9, wherein assigning the cybersecurity risk scores to the queued containers further comprises assigning additional cybersecurity risk scores to running containers, and wherein executing the one or more plugins configured with a controller entity further comprises:
migrating high-risk running containers from a third node to a high-risk node in response to the third node having an equal number of benign running containers and the high-risk running containers.

17. The method of claim 9, wherein the cybersecurity risk tolerances are adjusted based on the cybersecurity risk scores to load-balance the queued containers on the nodes.

18. The method of claim 9, wherein the container scheduler is a Kubernetes container scheduler, wherein the cybersecurity risk scores are converted to respective tolerations for the containers, and wherein the cybersecurity risk tolerances are converted to respective taints for the nodes.

19. A computer program product comprising one or more computer readable storage media, and program instructions collectively stored on the one or more computer readable storage media, the program instructions comprising instructions configured to cause one or more processors to perform a method comprising:
installing one or more plugins to a container scheduler configured to bind containers to nodes in a production environment; and
executing the one or more plugins to:
assign cybersecurity risk scores to queued containers;
assign cybersecurity risk tolerances to the nodes in the production environment; and
schedule the queued containers to the nodes based on compatible combinations of the cybersecurity risk scores and the cybersecurity risk tolerances.

20. The computer program product of claim 19, wherein assigning the cybersecurity risk scores to the queued containers further comprises assigning additional cybersecurity risk scores to running containers, and wherein the at least one plugin is further configured with a controller entity to perform a method further comprising:
migrate benign running containers from a first node to a benign node in response to the first node having more high-risk running containers than the benign running containers;
migrate high-risk running containers from a second node to a high-risk node in response to the second node having more benign running containers than the high-risk running containers; and
migrate high-risk running containers from a third node to the high-risk node in response to the third node having an equal number of the benign running containers and the high-risk running containers.
